(19) United States
(12) Patent Application Publication
(10) Pub. No.: US 2025/0191308 A1
(43) Pub. Date: Jun. 12, 2025

(54) TRANSITION OF PHYSICAL PROCESS ARTIFACTS FOR MIXED REALTY INTERACTIONS

(71) Applicant: SAP SE, Walldorf (DE)

(72) Inventor: Michael Kusber, Potsdam (DE)

(21) Appl. No.: 18/536,778

(22) Filed: Dec. 12, 2023

(51) Int. Cl. G06T 19/00; G06F 16/38; G06K 19/06; G06V 10/70

(52) U.S. Cl. CPC G06T 19/006; G06F 16/38; G06K 19/06009; G06V 10/70

(57) ABSTRACT

In some implementations, there is a method provided that detects a physical object in a video stream provided by a camera of an extended reality device providing an extended reality environment; extracts context information from at least a portion of the video stream associated with the physical object; queries, using the extracted context information, a system including a database to obtain at least one task and/or at least one document object that are associated with the extracted context information; receives the at least one task and/or the at least one document object that are associated with the extracted context information; and provides to the head-mounted display the at least one task and/or the at least one document object to cause the extended reality device to augment, based on the extracted context information from the physical object, the extended reality environment. Related systems, methods, and articles of manufacture are also disclosed.

### BACKGROUND

Virtual reality (VR) may be realized through a variety of technologies, such as a headset, a head-mounted display, VR glasses, and/or other devices that provide to a user at least in part a computer simulated (or generated) environment. For example, a user of a head-mounted display may interact with video, images, and audio, and, in some instances, the user may be able to manipulate objects in the VR environment using an input/output (I/O device, such as a computer, a mouse, a haptic controller, and/or the like. In the case of Augmented Reality (AR), AR technology may provide an overlay of digital objects and/or information on a real-world environment. For example, AR may provide the user via a device, such as a smart phone or other display device, a real-world view of a room with an overlay of digital objects. And, in the case of Mixed Reality (MR), MR allows a user to interact with both real-world and digital objects, such that the user can interact with and/or manipulate physical items in the real-world and the digital object of the virtual world. For example, a user of MR may see and interact with the real-world while also interacting with virtual objects in a virtual environment (e.g., the user wearing a head-mounted display may grab a real object and/or a virtual object).

### SUMMARY

In some embodiments, there is provided a system that includes at least one processor and at least one memory including program code which when executed by the at least one processor causes operations including detecting a physical object in a video stream provided by a camera of an extended reality device providing an extended reality environment; in response to the detecting, extracting context information from at least a portion of the video stream associated with the physical object; querying, using the extracted context information, a system including a database to obtain at least one task and/or at least one document object that are associated with the extracted context information; in response to the querying, receiving the at least one task and/or the at least one document object that are associated with the extracted context information; and in response to receiving, providing to the extended reality device the at least one task and/or at least one document object to cause the extended reality device to augment, based on the extracted context information from the physical object, the extended reality environment.

In some variations, one or more features disclosed herein can optionally be included in any feasible combination. The physical object may include a physical document. The extended reality device may provide the extended reality environment to a user of the extended reality device. The extended reality environment may be augment by presenting on a display of the extended reality device the detected physical object and at least one digital overlay presenting the at least one task and/or the at least one document object. The extended reality environment may present via a display comprised in the extended reality device a plurality of physical objects including the detected physical object and the at least one digital overlay presenting the at least one task and/or the at least one document object. The extended reality device may include a head-mounted device. The extended reality device may include at least one of a head-mounted display, a headset, a haptic controller, a smart phone, a computer including a display, and augmented reality glasses. The extracted context information may include at least one of a file number, a reference number, a process reference number, an invoice number, a purchase order number, an order number, a shipping tracking number, and a line item number. The detecting of the physical object may use a machine learning model to detect the physical object. The detecting of the physical object may use a machine readable code on the physical object to detect the physical object.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of a system for integrating physical objects in a virtual environment, in accordance with some embodiments;

FIG. 2 depicts an example of a user wearing a device to access a plurality of objects, in accordance with some embodiments;

FIG. 3 depicts an example of a process among devices, in accordance with some embodiments;

FIG. 4 depicts another example of a process, in accordance with some embodiments; and

FIG. 5 depicts a block diagram illustrating a computing system, in accordance with some example embodiments.

When practical, similar reference numbers denote similar structures, features, or elements.

### DETAILED DESCRIPTION

Augmented and/or mixed reality devices, such as a head-mounted display, gloves, and/or other devices (e.g., the HoloLens, Apple Vision Pro) may be used to allow a user to interact with data, such as data objects in new ways. As used herein, the phrase “extended reality” (XR) is used to refer generally to the technologies associated with virtual reality, augmented realty, and/or mixed reality. To illustrate further, a user wearing a head-mounted display (HMD) may search, access, and/or manipulate data objects in a database, which may provide an intuitive user experience. Use case scenarios may often start by accessing data from a digital data source, such as a database, and placing the data in the physical world for further interaction via the XR environment provided by for example the head-mounted display. This scenario may rely on the presence of the digital object part to provide the XR experience. However, this ignores the fact that in many instances, the workflow (e.g., process) does not have a complete digital representation of all of the data objects associated with a workflow. For example, a workflow may include artifacts that are physical items. These artifacts may include for example invoices, delivery notes, contracts, and/or other documents which are in a physical form, such as a printed document that is not yet stored in the database, as well as other physical objects, such as a good or a part.

In some embodiments, there is provided a way to use these physical objects (also referred to as artifacts) as part of a workflow process using XR devices, such as a head-mounted display, to provide document search, storage, and extraction services.

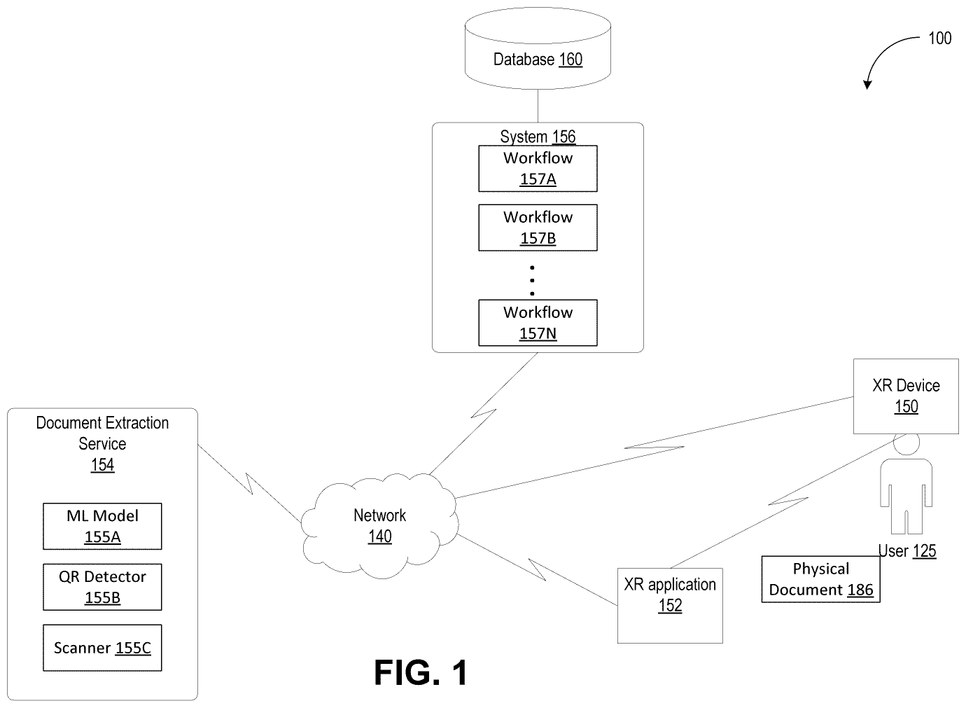

FIG. 1 depicts an example of a system 100 for integrating physical objects, such as physical documents, into an XR environment, in accordance with some embodiments.

The system 100 may include an XR device 150, which is accessed by for example a user 125. The system may further include an XR application 152, which may be coupled to (or comprised with) the XR device 150. The XR application may couple to a network 140. Moreover, the system may include a document extraction service 154, a system 156, such as an enterprise resource management system or other type of system, coupled to a database management system 160.

The XR device 150 may be implemented using one or more of the following: a head-mounted display, a headset, a haptic controller, a smart phone, a computer including a display, AR glasses (also referred to as smart glasses), and/or any other input and/or (“/”) output device that can be used by the user 125 to interact or access an XR environment including data objects accessed from the system 156 and the coupled database 160.

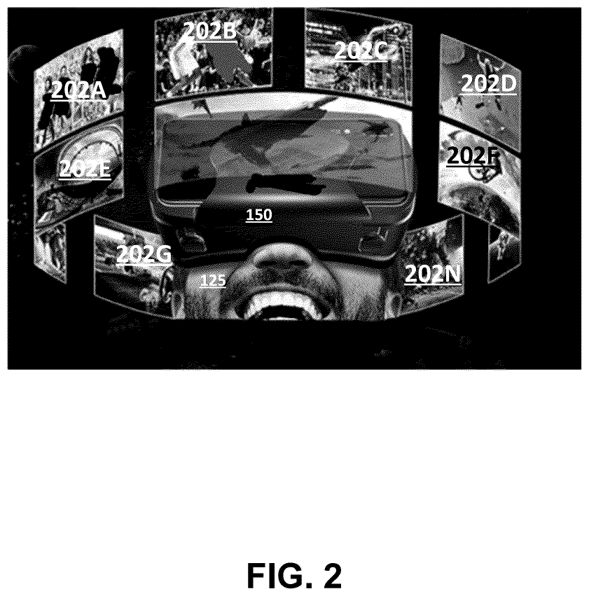

FIG. 2 depicts an example of an XR device 150, which in this example is a head-mounted device, although other types of XR devices may be used as well. In the example of FIG. 2, the XR device is being used by the user 150 to access and interact with a plurality of objects, such as data objects (also referred to as document and document objects) 202A-N retrieved from the database 160, in an XR environment (e.g., as digital overlay of objects over a real-world view provided by the XR device). The XR device may include at least one processor, at least one memory (including instructions such as code to provide aspects of the XR device), at least one display, at least one camera, at least one speaker, at least one microphone, at least one eye tracker, at least one proximity sensor, and/or other input/output components (as well as sensors) to enable the user 125 to interact with objects in the real and/or virtual world provided.

Referring again to FIG. 1, the XR application 152 may be an application that interacts with at least the XR device 150, the document extraction service 154, and the system 156 (and/or database 160). In some implementations, the XR application 152 may coordinate the processing of the information obtained from the real world, interprets real world objects (e.g., objects present in the real world rather than digital (virtual) objects), and extracts information and data objects in the system such that workflows, tasks, and/or other data objects associated with a physical object can be identified. For example, the XR application may link detected line items of a received paper based order document to data objects (e.g., materials produced and storage amounts) obtained from a database instance. Moreover, the XR application may, in this example, determine a workflow or task connected to the paper-based order, where the workflow may include a first task for estimation of logistics costs to deliver and a second task to present different options for routes in the head-mounted display.

The network 140 may be a wired network, a bus, one or more links, and/or a wireless network. Examples of the network include a wide area network (WAN), a local area network (LAN), a virtual local area network (VLAN), the Internet, and/or the like.

The document extraction service 154 may detect the presence of physical documents being viewed by the XR device 150. Alternatively, or additionally, the document extraction service may also segment the detected document out of an image. Alternatively, or additionally, the document extraction service may also scan at least a portion of the detected document to provide one or more elements, such as context information, from the document. Although the document extraction service 154 is depicted separate from the XR application 152, in some implementations, the one or more aspects of the document extraction service 154 may be comprised in the XR application. In some implementations, the document extraction service 154 may determine context or other high-level information about (or from) a document or object. For example, the document extraction service 154 may be used to detect text and extract the text into a machine-readable format. Alternatively, or additionally, the document extraction service 154 may extract context information (e.g., extract a label which says “serial number 1234”). In this example, the XR application may take this extracted information and determine that the paper-based note is a shipping document. The XR application may thus coordinate actions, such as a look up of the detected order ID, search for the material using system column named with synonyms for identifiers, and/or the like.

The system 156 may comprise an enterprise resource planning (ERP) system, a customer relationship management (CRM) software application, and/or other types of systems or applications. In the example of FIG. 1, the system 156 may include one or more workflows 157A-N. These workflows may be associated with one or more tasks and one or more data objects, such as a document object stored in the database 160. In this example, the document object may be an electronic document or other form of data stored at the database and object via a database query (e.g., an SQL query). Referring to the previous example, when a shipping document is received, the type of document (which in this example is shipping document) may be mapped to one or more workflows. To illustrate further, the shipping document may trigger workflow 157A. This workflow may define one or more tasks for one or more users and further include links to other document objects stored at the database 160. Referring to the shipping document example, the workflow 157A may be linked to an inspection document object, such as an electronic document, stored at the database 160. This inspection document may be presented on the display of the XR device 150 to allow the user 150 to inspect a product associated with the shipping document.

The database 160 may comprise a database management system including a persistence layer. The database 160 may be an on-premise database management system, a cloud service based database management system, and/or a hybrid of both. Alternatively, or additionally, the database 160 may comprise an in-memory database, an example of which is SAP's HANA database (although other types of databases may be used as well). Alternatively, or additionally, the database 160 may comprise a column store database. The phrase “in-memory database” refers to a database management system in which main memory provides the primary computer data storage for transaction data used to respond to queries for example, such that most if not all of the data typically used for transactions can be kept in main memory, rather than persisted to a slower type of storage such as disk based storage. The use of the in-memory database provides faster queries, when compared to more disk base storage solutions. The column store database (or column store database management system) refers to a database management system that indexes the data of the columns of a database table, such that the column indexes are stored rather than storing row data. In a column store database (also referred to as a column-oriented database), the values in the column may be compressed using a dictionary, such that the values of a column index can be decoded into the original data using the dictionary. As the values in a column may be of a similar type (e.g., a column of cites, a column of countries, a column of amounts), the use of the dictionary can provide some compression, when compared to row-oriented database where the values in a row can be dissimilar. Alternatively, or additionally, the database 160 may comprise a row store database.

In the system 100, objects for documents (“document objects” also referred to as “data objects”) for a given workflow process may be stored in the database 160, for example. However, some documents used in the workflow process may at least initially be in a paper-based format. For example, when a product is first received, a paper shipping document may be received and signed by a user at a shipping and receiving department. But this paper shipping document may not be stored in the system 156 or the database 160 since the paper document in this example has just been received by a user when the product is received. As such, there may not be a mapping (e.g., link) between the paper document and a corresponding workflow. This lack of a mapping may decrease the efficiency of the system 156 as the user 156 may have to perform repeated searches to identify which workflow process should be used given the paper document (wasting thus processing, memory, and/or network resources).

Some documents may be stored in the system 156 including the database 160, and these stored documents may have context information that identifies the document to a user (and/or the system 156 and the database 160) and provides a mapping to a workflow, such as one or more of the workflows 157A-N. For example, the context information may include one or more of the following: a file number, a reference number or link to a prior document (e.g., prior correspondence or email), a process reference number, an invoice number, a purchase order number, an order number, a shipping tracking number, one or more line item numbers for the items of a purchase order, and/or the like.

If the user 125 wants to access and interact with a workflow process, such as a workflow process 157A, the user in this example of a paper shipping document would need to manually determine if the new paper shipping document is stored in the ERP system 156 and database 160, manually identify relevant identifying context information for the received paper based document, and/or perform repeated searches to identify which workflow process should be used given the paper shipping document (which as noted wastes processing, memory, and/or network resources). For example, document context information, such as a purchase order number printed on the paper shipping document, may be used by the user 125 to manually search to see if the paper shipping document is already stored and/or manually search for the corresponding workflow associated with that the paper shipping document. As the user 125 is operating in the XR environment, the user in this example may need to (in a sense) exit the XR world to do the manual searches.

In some embodiments, the images of the video stream output by a camera of the XR device 150 may be monitored to detect the presence of a physical object, such as a physical document 186, being viewed by the user 125. Referring to FIG. 1, the XR device 150 associated with the user 125 may view the physical document 186 (e.g., paper document) by using a camera of the XR device to capture the physical document and present the physical document on a display of the XR device. In this example, the output of the camera may detect the presence of the physical document being viewed by the XR device (which is being used by the user 125). For example, the output of the camera may comprise images. As used herein, images refer to digital data which may be in various forms, such as video frames, pixel based images, and/or other forms.

In some embodiments, the detection of the physical document 186 may be via a machine learning (ML) model, a QR code (e.g., machine readable code), and/or the like. In the case the ML model, such as ML model 155A, the ML model (e.g., a convolutional neural network or other type of neural network or ML model) may be trained to detect documents in output images captured by the camera of the XR device 150. When trained, the trained ML model may be used to detect the presence of the physical document in the output images captured by the camera of the XR device 150. Alternatively, or additionally, the document extraction service 154 may extract the detected document by for example segmenting the detected document or a portion of the detected document. This segmentation (extraction) may be performed in a variety of ways, such as using a ML model, thresholding technology, clustering technology, edge detection technology, and/or the like.

Alternatively, or additionally, the document detection may be performed using a QR code. For example, the QR engine may detect a QR code (or other machine-readable label) on a physical document. In some embodiments, the detection of the physical document (e.g., using ML model and/or QR code) may be performed by (or cause another service to detect) the document extraction service 154. Alternatively, or additionally, the XR application 152 may perform the detection of the physical document (e.g., using ML model and/or QR code). When the document is detected, the document extraction service 154 may extract the detected document by for example segmenting the detected document or a portion of the detected document. Alternatively, or additionally, the XR application 152 may perform the segmenting.

In some embodiments, the document extraction service 154 may detect the physical document 186 as noted. The document extraction service may include a scanner 155C service that automatically scans the physical document (or a portion of the document) to extract information from the document. For example, the XR device 150 (and in particular a camera of the XR device) may view the physical document 186. The document extraction service 154 may detect (e.g., from the image or video output of the XR device) the physical document and then extract one or more elements from the document. For example, the document extraction service 154 may extract one or more elements from the document, such as context information. To illustrate further, the document extraction service 154 may extract (e.g., using the scanner 155C) context information such as an invoice number or a purchase order number. This context information may be used to determine a workflow, such as one of the workflows 157A-N, for example.

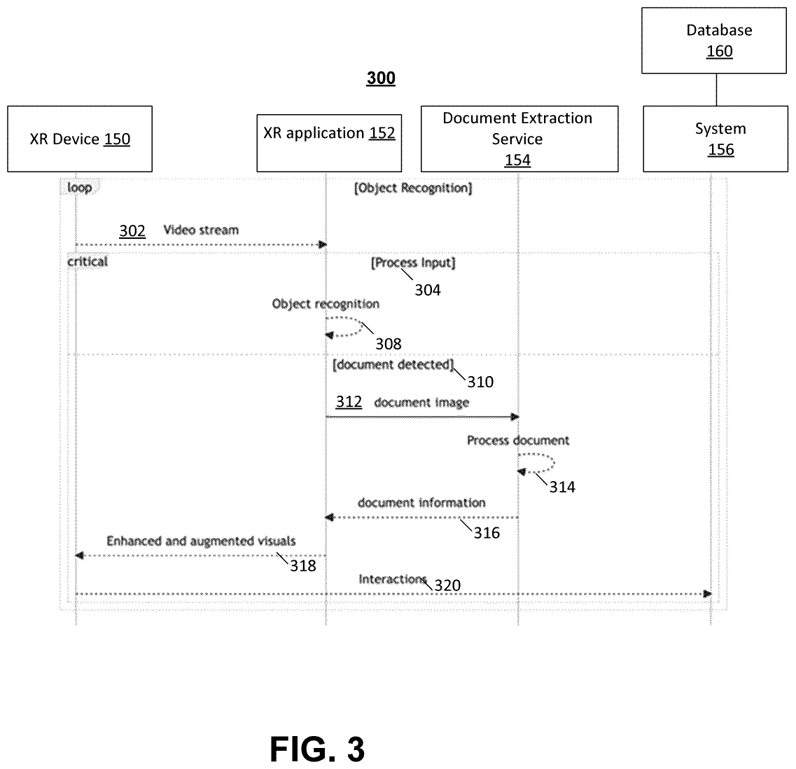

FIG. 3 depicts an example of a process 300 for using physical documents in an extended reality (XR) environment, in accordance with some embodiments.

To illustrate with a use case example, the user 125 accessing the XR device 150 (e.g., a head-mounted display) may receive a physical document 186, such as a delivery note for one or more components needed for manufacturing a product. In this example, the user 125 may need to perform one or more workflows 157A-N including one or more tasks, such as assess the quality of the delivered goods associated with the delivery note, update a physical delivery order document, plan a manufacturing process given the new one or more components, and/or the like. By viewing the physical document 186 (which in this example is a paper delivery note), the system 100 detects the physical document, extracts certain information, and looks up related one or more workflows (each of which may include one or more tasks) and/or looks up objects (e.g., other document objects associated with a workflow). In this use case example, the user 125 may point a finger on the physical document 186 and in particular at a location on the physical document where context information such as an order number is located. This may be viewed and experienced in the XR environment using the XR device 150. Via the XR device for example, the finger pointing may cause a detection of the physical document, an extraction of the order number, and a pop-up window containing one or more tasks for a workflow mapped to the order number. This example shows that the user 125 may remain in the XR environment as the physical document 186 (e.g., paper delivery note) is directly usable in the digital XR environment even though the paper delivery note is not digitally stored as a document object in the database 160. Similarly, pointing and dragging at another location on the physical document 186 (e.g., the written note) where context information such as a line item is located may cause a detection of the physical document, an extraction of the line number and contents of the line number, and a pop up window in a 3D model of the good (indicated by the line number) with relevant areas marked and annotated to guide the user 125 through quality checks of the good.

At 302, the XR device 150 may provide data, such as a stream of images or video stream, to the XR application 152. The data may include one or more images of what is being viewed by the XR device while the XR device is being used by the user 125. For example, the data may include images of the physical document 186.

At 304, the XR application 152 may process the data, such as the video stream, to detect the presence, at 308, of an object of interest, such as a physical object (e.g., physical document 186). For example, the XR application 152 may process the data received at 302 using for example the ML model 155A and/or QR detector 155B to detect whether an object, such as the physical document 186, is present in the data. The XR application may process the stream and detect object, such as detect whether there are any processible classes of artifacts, such as a document, a label, an email, and/or the like present in the stream.

At 310, if the physical object is detected, the process proceeds as follows. In response to the object of interest (e.g., an artifact such as a physical document 186) being detected, an image of at least a portion of the detected object of interest (e.g., physical document 186) may be provided at 312 to the document extraction service 154.

At 314, the document extraction service 154 may process the received image of for example the physical document 186 to extract context information, such as an invoice number, shipping number, and/or the like. In some implementations, the document extraction service may scan the document to determine as much context information from the image of the physical document 186 as possible. For example, the document extraction service may extract and convert text on the artifact into machine-readable form with annotation(s) of a position of the text on the artifact, such as the image of the document. Alternatively, or additionally, the document extraction service may interpret a portion of the text and indicate that the text corresponds an identifier for a line item at a certain point on an invoice and the line item's position relative to the input image. At 314, the extracted context information may be used to query the system 156 including the database 160. This query may be used to identify for example a workflow, such as one of the workflows 157A-N (each of which may include one or more tasks). Alternatively, or additionally, the query may be used to obtain other data objects, such as document objects or other types of objects.

At 316, the document extraction service 154 may provide information, such as responsive context information, identified workflow(s), identified task(s), and/or data object(s), to the XR application 152. This provided information may then be provided to the XR device 150 to cause the XR device to augment the user's XR environment with the provided information. For, example, given a shipping document with line items, the document is detected as being in the context of an order made in the system, and the amounts ordered may be added to the lines to make it easier for a user to determine derivations. Alternatively, or additionally, there may be additional processing and determining of context, such as determining a workflow associated to the kind of material, loading of additional information from the system, preparing of responsive information (e.g., position and kind of UI elements to overlay on the document, metadata to define what the next action for the user could be from this point, etc.), and/or the like. At 318, the responsive information may be sent to the XR application 152, which can be overlayed for example on display of the XR device 150, although the overlay may include other aspects such as sound, haptics, and/or the like.

At 320, the XR device may further interact with system 156 including the database 160. For example, an expensive item, such as a high-valued part, may be received and subject to quality assurance when when received. The user's 125 may have their vision enhanced by displaying (on the XR device's display) a user interface element, such as a button, to start the process of performing the quality assurance. When the user selects the button, a step by step guide is presented to the display of the XR device to guide the user through the quality assurance checks of the expensive item

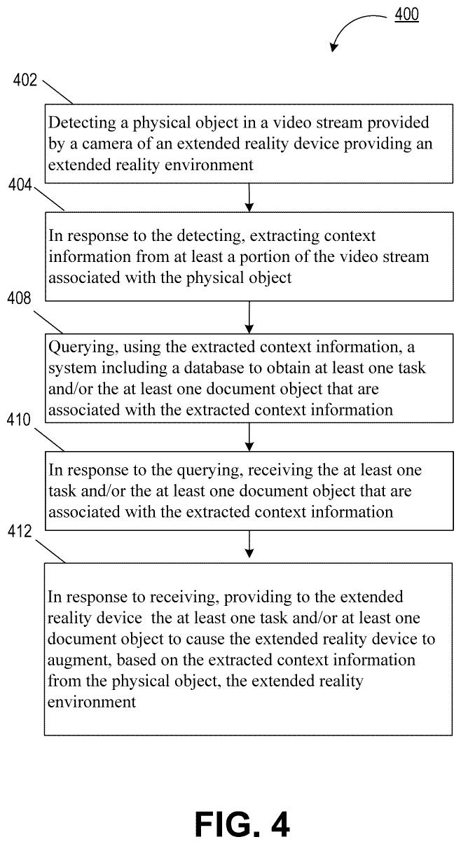

FIG. 4 depicts a process 400 for augmenting an XR environment based on a physical document viewed by an XR device, in accordance with some embodiments.

At 402, a physical object, such as a physical document, may be detected in a video stream provided by a camera of an XR device (e.g., a head-mounted device or headset and/or the like) that provides to a user an extended reality environment. The extended reality device may be used to provide the extended reality environment to a user of the extended reality device. The extended reality environment may be augmented by presenting on a display of the extended reality device the detected physical object (as well as other physical objects captured by the camera of the XR device) and at least one digital overlay presenting the at least one task and/or at the least one document object. The extended reality device may include a head-mounted display, a headset, a haptic controller, a smart phone, a computer including a display, and/or augmented reality glasses. The detecting of the physical object may use a machine learning model to detect the physical object. Alternatively, or additionally, the detecting of the physical object may use a machine-readable code on the physical object to detect the physical object.

At 404, context information may be extracted from at least a portion of the video stream associated with the physical object, such as a physical document. This may be done in response to the detecting. The extracted context information may be a file number, a reference number, a process reference number, an invoice number, a purchase order number, an order number, a shipping tracking number, and a line item number, and/or other information obtained about the physical object, such as the physical object captured by the camera. At 408, a system may be queried using the extracted context information. The system may be coupled to a database, so the query is used to obtain at least one task and/or at least one document object that are associated with the extracted context information. The task may be a step in a workflow, for example. To illustrate further, the task (which may be part of a larger workflow of tasks) may be to perform a quality assurance check on a physical item, such as the physical item itself or a paper document with an identifier, such as a part number, for the physical item. In this example, the document object may be a quality assurance checklist indicating what steps to perform for the auality assurance on the physical item. This quality assurance checklist may be presented to a user via the XR device, such as a head-mounted device.

At 410, in response to the query, the at least one task and/or the at least one document object that are associated with the extracted context information may be received. At 412, in response to receiving, the extended reality device (e.g., a head-mounted display and/or the like) may be provided with the at least one task and/or at least one document object to cause the head-mounted headset to augment, based on the extracted context information form the physical object, the extended reality environment being provided to the user.

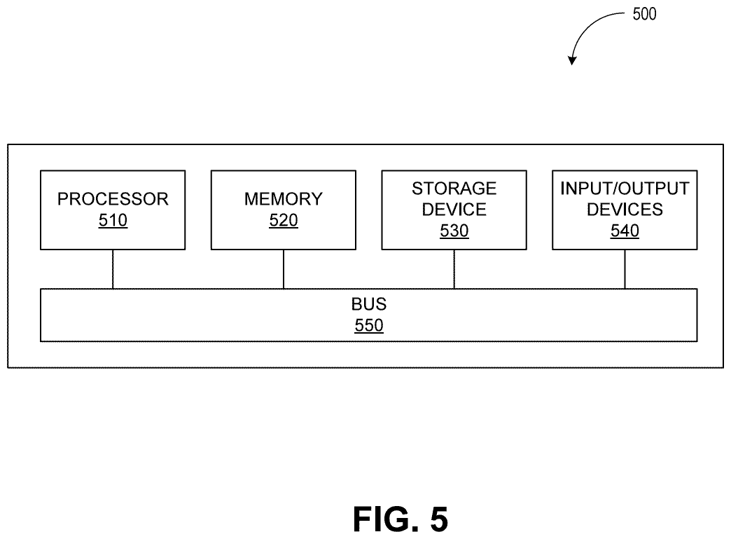

FIG. 5 depicts a block diagram illustrating a computing system 500, in accordance with some example embodiments. Referring to FIGS. 1-4, the computing system 500 can be used to implement the system 500 and/or any of the components therein (e.g., the document extraction service 154, the database 160, the XR device 150, and/or other components therein). As shown in FIG. 5, computing system 500 can include a processor 510, a memory 520, a storage device 530, and an input/output device 540. The processor 510, the memory 520, the storage device 530, and the input/output device 540 can be interconnected via a system bus 550. The processor 510 is capable of processing instructions for execution within the computing system 500. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540. The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces. According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one processor; and
at least one memory including program code which when executed by the at least one processor causes operations comprising:
   detecting a physical object in a video stream provided by a camera of an extended reality device providing an extended reality environment;
   in response to the detecting, extracting context information from at least a portion of the video stream associated with the physical object;
   querying, using the extracted context information, a system including a database to obtain at least one task and/or at least one document object that are associated with the extracted context information;
   in response to the querying, receiving the at least one task and/or the at least one document object that are associated with the extracted context information; and in response to receiving, providing to the extended reality device the at least one task and/or the at least one document object to cause the extended reality device to augment, based on the extracted context information from the physical object, the extended reality environment.

Example 2: The system of Example 1, wherein the physical object comprises a physical document.

Example 3: The system of any of Examples 1-2, wherein the extended reality device provides the extended reality environment to a user of the extended reality device.

Example 4: The system of any of Examples 1-3, wherein the extended reality environment is augmented by presenting on a display of the extended reality device the detected physical object and at least one digital overlay presenting the at least one task and/or the at least one document object.

Example 5: The system of any of Examples 1-4, wherein the extended reality environment presents via a display comprised in the extended reality device a plurality of physical objects including the detected physical object and the at least one digital overlay presenting the at least one task and/or the at least one document object.

Example 6: The system of any of Examples 1-5, wherein the at least one document object comprises at least one electronic document stored in the database, and wherein the at least one task is part of a workflow associated with the at least one document object.

Example 7: The system of any of Examples 1-6, wherein the extended reality device comprises at least one of a head-mounted display, a headset, a haptic controller, a smart phone, a computer including a display, and augmented reality glasses.

Example 8: The system of any of Examples 1-7, wherein the extracted context information comprises at least one of a file number, a reference number, a process reference number, an invoice number, a purchase order number, an order number, a shipping tracking number, and a line item number.

Example 9: The system of any of Examples 1-8, wherein the detecting of the physical object uses a machine learning model to detect the physical object.

Example 10: The system of any of Examples 1-9, wherein the detecting of the physical object uses a machine readable code on the physical object to detect the physical object.

Example 11: A method comprising: detecting a physical object in a video stream provided by a camera of an extended reality device providing an extended reality environment;
in response to the detecting, extracting context information from at least a portion of the video stream associated with the physical object;
querying, using the extracted context information, a system including a database to obtain at least one task and/or at least one document object that are associated with the extracted context information;
in response to the querying, receiving the at least one task and/or the at least one document object that are associated with the extracted context information; and
in response to receiving, providing to the extended reality device the at least one task and/or the at least one document object to cause the extended reality device to augment, based on the extracted context information from the physical object, the extended reality environment.

Example 12: The method of Example 11, wherein the physical object comprises a physical document.

Example 13: The method of any of Examples 11-12, wherein the extended reality device provides the extended reality environment to a user of the extended reality device.

Example 14: The method of any of Examples 11-13, wherein the extended reality environment is augmented by presenting on a display of the extended reality device the detected physical object and at least one digital overlay presenting the at least one task and/or the at least one document object.

Example 15: The method of any of Examples 11-14, wherein the extended reality environment presents via a display comprised in the extended reality device a plurality of physical objects including the detected physical object and the at least one digital overlay presenting the at least one task and/or at the least one document object.

Example 16: The method of any of Examples 11-15, wherein the at least one document object comprises at least one electronic document stored in the database, and wherein the at least one task is part of a workflow associated with the at least one document object.

Example 17: The method of any of Examples 11-16, wherein the extended reality device comprises at least one of a head-mounted display, a headset, a haptic controller, a smart phone, a computer including a display, and augmented reality glasses.

Example 18: The method of any of Examples 11-17, wherein the extracted context information comprises at least one of a file number, a reference number, a process reference number, an invoice number, a purchase order number, an order number, a shipping tracking number, and a line item number.

Example 19: The method of any of Examples 11-18, wherein the detecting of the physical object uses a machine learning model to detect the physical object.

Example 20: A non-transitory computer-readable storage medium including program code which when executed by at least one processor causes operations comprising:
detecting a physical object in a video stream provided by a camera of an extended reality device providing an extended reality environment;
in response to the detecting, extracting context information from at least a portion of the video stream associated with the physical object;
querying, using the extracted context information, a system including a database to obtain at least one task and/or at least one document object that are associated with the extracted context information;
in response to the querying, receiving the at least one task and/or the at least one document object that are associated with the extracted context information; and
in response to receiving, providing to extended reality device the at least one task and/or the at least one document object to cause the extended reality device to augment, based on the extracted context information from the physical object, the extended reality environment.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory including program code which when executed by the at least one processor causes operations comprising:
detecting a physical object in a video stream provided by a camera of an extended reality device providing an extended reality environment;
in response to the detecting, extracting context information from at least a portion of the video stream associated with the physical object;
querying, using the extracted context information, a system including a database to obtain at least one task and/or at least one document object that are associated with the extracted context information;
in response to the querying, receiving the at least one task and/or the at least one document object that are associated with the extracted context information; and
in response to receiving, providing to the extended reality device the at least one task and/or the at least one document object to cause the extended reality device to augment, based on the extracted context information from the physical object, the extended reality environment.

2. The system of claim 1, wherein the physical object comprises a physical document.

3. The system of claim 1, wherein the extended reality device provides the extended reality environment to a user of the extended reality device.

4. The system of claim 1, wherein the extended reality environment is augmented by presenting on a display of the extended reality device the detected physical object and at least one digital overlay presenting the at least one task and/or the at least one document object.

5. The system of claim 4, wherein the extended reality environment presents via a display comprised in the extended reality device a plurality of physical objects including the detected physical object and the at least one digital overlay presenting the at least one task and/or the at least one document object.

6. The system of claim 5, wherein the at least one document object comprises at least one electronic document stored in the database, and wherein the at least one task is part of a workflow associated with the at least one document object.

7. The system of claim 1, wherein the extended reality device comprises at least one of a head-mounted display, a headset, a haptic controller, a smart phone, a computer including a display, and augmented reality glasses.

8. The system of claim 1, wherein the extracted context information comprises at least one of a file number, a reference number, a process reference number, an invoice number, a purchase order number, an order number, a shipping tracking number, and a line item number.

9. The system of claim 1, wherein the detecting of the physical object uses a machine learning model to detect the physical object.

10. The system of claim 1, wherein the detecting of the physical object uses a machine readable code on the physical object to detect the physical object.

11. A method comprising:
detecting a physical object in a video stream provided by a camera of an extended reality device providing an extended reality environment;
in response to the detecting, extracting context information from at least a portion of the video stream associated with the physical object;
querying, using the extracted context information, a system including a database to obtain at least one task and/or at least one document object that are associated with the extracted context information;
in response to the querying, receiving the at least one task and/or the at least one document object that are associated with the extracted context information; and
in response to receiving, providing to the extended reality device the at least one task and/or the at least one document object to cause the extended reality device to augment, based on the extracted context information from the physical object, the extended reality environment.

12. The method of claim 11, wherein the physical object comprises a physical document.

13. The method of claim 11, wherein the extended reality device provides the extended reality environment to a user of the extended reality device.

14. The method of claim 11, wherein the extended reality environment is augmented by presenting on a display of the extended reality device the detected physical object and at least one digital overlay presenting the at least one task and/or the at least one document object.

15. The method of claim 14, wherein the extended reality environment presents via a display comprised in the extended reality device a plurality of physical objects including the detected physical object and the at least one digital overlay presenting the at least one task and/or the at least one document object.

16. The method of claim 15, wherein the at least one document object comprises at least one electronic document stored in the database, and wherein the at least one task is part of a workflow associated with the at least one document object.

17. The method of claim 11, wherein the extended reality device comprises at least one of a head-mounted display, a headset, a haptic controller, a smart phone, a computer including a display, and augmented reality glasses.

18. The method of claim 11, wherein the extracted context information comprises at least one of a file number, a reference number, a process reference number, an invoice number, a purchase order number, an order number, a shipping tracking number, and a line item number.

19. The method of claim 11, wherein the detecting of the physical object uses a machine learning model to detect the physical object.

20. A non-transitory computer-readable storage medium including program code which when executed by at least one processor causes operations comprising:
detecting a physical object in a video stream provided by a camera of an extended reality device providing an extended reality environment;
in response to the detecting, extracting context information from at least a portion of the video stream associated with the physical object;
querying, using the extracted context information, a system including a database to obtain at least one task and/or at least one document object that are associated with the extracted context information;
in response to the querying, receiving the at least one task and/or the at least one document object that are associated with the extracted context information; and
in response to receiving, providing to the extended reality device the at least one task and/or the at least one document object to cause the extended reality device to augment, based on the extracted context information from the physical object, the extended reality environment.
